(19) United States
(12) Patent Application Publication
(10) Pub. No.: US 2011/0299678 A1
(43) Pub. Date: Dec. 8, 2011

(54) SECURE MEANS FOR GENERATING A SPECIFIC KEY FROM UNRELATED PARAMETERS

(76) Inventors: Alexander Roger DEAS, Dalkeith (GB); David COYNE, Glenrothes (GB)

(21) Appl. No.: 13/114,470

(22) Filed: May 24, 2011

Related U.S. Application Data
(60) Provisional application No. 61/351,998, filed on Jun. 7, 2010.

(51) Int. Cl. H04L 9/28

(52) U.S. Cl. 380/28

(57) ABSTRACT

A technique and method for improving the security of the usage of a key in devices or systems with modes of operation that must be secured whereby the key has multiple fields with timing information that must be matched to transitions of a randomly generated clock, the randomly generated clock derived from a fixed frequency clock, whereby tampering of the fixed frequency clock will result in detection of the security attack and exit from the secure mode of operation.

### BACKGROUND OF THE INVENTION

1. Technical Field

The present invention relates to improving the security of stored data used in a device, for example a cryptographic key used in an integrated circuit mounted on a smart card used cable television access or for authorizing banking transactions. For simplicity, without loss of generality, the term “key” will be used to refer to any sensitive data, whether it is a cryptographic key, such as a symmetric key or a private key as part of a private and public key pair, or another piece of particularly sensitive data.

2. Background of the Invention

A fundamental problem exists with smart cards and entertainment media where an cryptographic key or other sensitive data is stored on a device issued to a user, along with a PIN or access code. The device may fall into the hands of a person who may attack the physical device to obtain the cryptographic key.

The protocol used in smart cards is generally published, for example by GlobalPlatform, or by EMVCo for the Mastercard, Visa, American Express, JCB cards. Most cards presently use a symmetric cryptographic key issued by the bank or media provider, but newer cards are using Elliptic Curve keys which are an asymmetric key comprising a public and private key pair. In each case there is a key stored on the device. If an attacker obtains the key, then transactions may be cloned or modified, or for a cable media access point, the user may obtain access to film and other content without paying the relevant charges.

To prevent smart cards being cloned, many countermeasures are used. Most of these can be circumvented. The core problem is there is a key stored on the device.

Attempts have been made to make it more difficult to access stored keys, including by algorithmic encryption where the decryption requires a personal identification number (PIN), a set of biometric tags, or the output from a device of specific or non-cloneable structure. The algorithmic encryption must transform the input parameters into a specific number—the key. The key is not just any number, but is usually a large prime, factor or set of surface coefficients corresponding to a second key, a public key. As the seed parameters from a PIN, biometric tag set or device specific structure are fixed, and the key is fixed, the level of encryption available to generate the key by algorithmic encryption is very weak. Often the parameter encryption comprises just a simple matching process, which if true, releases the key to be read directly from memory. Encoding the key with, for example, a cipher, just adds one extra level of complexity to the reverse engineering process. It would be beneficial to increase the complexity of determining the key by more than the one level obtained from logically encoding the key.

The key relevant hardware elements supporting a typical smart card authorisation process is shown in FIG. 1, where a Terminal 1, obtains a PIN and sends it to Device 2 which is an integrated circuit on a smart card, as part of an authentication sequence. Terminal 1 comprises hardware 10 generating clock 11 to synchronise the transfer of data and control signals in bus 12 between Terminal 1 and device 2. Device 2 comprises key memory 20 and processor 21, key memory 20 connected to processor 21 allowing data to be read from key memory 20 and written to key memory 20 through data bus 22 and control bus 23. Processor 21 further connects to key issuer hardware 10 through data bus 12 used to transfer data between processor 21 and key issuer hardware 10 synchronously using clock 11. Processor 21 may have additional input/output connections 24 to other hardware, for example, cryptographic accelerators, random number generators, and attack detection circuits comprising supply voltage sensors, light sensor, temperature sensor, fault attack sensor, differential power analysis attack sensor, watchdog sensor and others. The key stored in Key memory 20 may be encrypted, but in that case there is a secondary key also stored and once that is found the primary key can be decrypted easily.

In the prior art of FIG. 1 where the key is stored in key memory 20, key memory external to processor 21, the key may be determined by an observer monitoring accesses to key memory 20 when it is known that the key is required for encryption purposes. An observer may be able to remove the package and passivation over the device 2 to use micro-probes to physically connect an oscilloscope or logic analyser to the data bus 22 and control bus 23 and monitor data. More commonly, when key memory 20 is embedded within an integrated circuit also containing processor 21 that encrypts the memory and buses, it may be possible to determine the stored key by such means as differential power analysis, very near field probes gathering the EMI or clock signatures, Kelvin probes on an atomic force microscope, monitoring the light from the transistor junctions in the memory or the memory bus or other means of reading memory contents using conventional reverse engineering. Once the key is known it is possible to modify transactions or clone the integrated circuit and create a smart card using, for example, a field programmable gate array (FPGA) gaining access to, for example, secret, personal information or bank details.

In many cases the key can be detected as it is read from memory, despite attempts to mask the transfer. For example, spread spectrum clock noise is easily removed by triggering from the clock itself: clocks cause a large power drain and cover a large portion of the chip, which means their electromagnetic interference (EMI) signature is also large and can usually be picked out using a very near field probe. Simple spread spectrum clocking, as well as injected noise in the power voltage, is removed easily by statistical sampling of multiple key transfers or encryptions, or scanning using very accurate timing. Attempts to minimise the emissions by using differential logic are frustrated when the attacker reduces the supply voltage to the point where the logic is driven into saturation: this reduction need be only very momentary, and the short glitch reducing power supplies is hard to detect.

Attempts are made on modern smart card devices to detect tampering with the device, but an attacker can often disable the tamper circuitry using a focused ion beam (FIB) machine; a widely available and inexpensive process for modifying integrated circuits. In other cases, the range of values from the PIN number, biometrics or device specific structure is small enough that an exhaustive search is possible; for example most PIN numbers comprise just four decimal digits so once the PIN attempt counter is disabled the PIN can be found easily.

Methods to protect devices against intrusive attacks have been employed, for example, in the use of metal layers or traces covering one or both sides of the device. The change in physical properties of the materials such as resistance or capacitance is used as a means to detect the presence of an intrusive attack and, when powered up, corrupt secure information. One example is US provisional patent 2010/0026326 metallic structures are used as part of a resistance sensing network. Another example is reported to be the Dallas DS5002FPM secure microprocessor which uses a meandering top metal pattern to detect damage to the metal pattern and cause the device to halt operation. One shortcoming to these approaches is that the metal pattern is often quite large and so small openings can be created without disturbing the pattern and observe the device operation using standard reverse engineering techniques. Another approach in US provision patent 2006/0168702 makes use of metal fill patterns that are required in sub-micron and deep sub-micron integrated circuit devices to form connectivity networks making circuit tracing more difficult and physically obscure circuits. However, this is no real defence against modern reverse engineering tools: attempts to cover the device with a screen are overcome by the attacker bonding the relevant screen via area to an equivalent resistor.

Yet further, in US provisional patent 2003/0132777 the use of a metal shield is described where the change in capacitance is detected as a result of tampering. Similarly in US provisional patent 2002/0199111 resistance and/or capacitance changes are detected in a cocoon of material on or around an integrated circuit device. These are again overcome easily by bonding in an equivalent capacitor to the area removed.

These references serve to indicate the lengths taken to protect an integrated circuit device. The use of additional metal layers or special patterns in metal layers on either side of the integrated circuit can increase the difficulty but rarely defeat reverse engineering attacks.

Other methods have been reported for increasing the difficulty to reverse engineer secret data within devices, for example, physical unclonable functions (PUFs). A PUF is defined as a mathematical function that is derived from the behaviour of an object or device. A PUF may be a function that is easy to evaluate but hard to characterise thereby making the cloning of the function difficult.

In WO 2008/015603 a random number is generated by measuring the breakdown voltage of a string of diodes. This method when applied to a modern low-voltage integrated circuit requires a circuit that generates a voltage across one or more diodes, a voltage that exceeds the nominal diode breakdown voltage, and a circuit that can detect the onset of breakdown and measure the applied voltage. Such a methods are essentially an analogue encoding of a number: they require significant analogue circuitry and may possibly also require the use of devices capable of withstanding larger voltages than the devices normally used in an integrated circuit providing the same function as the one in which the diode string random number generator is created. Another issue with the use of diodes in a conventional planar semiconductor manufacturing process is the injection of electrons into the surface oxide close to the diode junction resulting in changes to the breakdown voltage over time making this method impractical for multiple measurement events and longevity of any secret key dependent on stable voltage measurement.

In WO 2007/031908 a coating is applied to an integrated circuit wherein particles of different materials each with different dielectric constants are embedded in the coating. An array of sensors within the integrated circuit measures local capacitance values each using an analogue to digital converter, the capacitance sensed by the sensors modified by the presence, absence, proximity and dielectric constant of the particles in the coating applied to the integrated circuit. The formation of a coat on an integrated circuit is a non-standard process and therefore adds cost to the integrated circuit.

In the paper “Silicon Physical Random Functions, Gassend, Clarke, van Dijk and Devadas, Proceedings of the Computer and Communication Security Conference 2006” a silicon PUF is disclosed where a PUF is formed from the transient response of an integrated circuit to a challenge dependent on a the delays of wires and devices within the integrated circuit, multiple challenge-response pairs generated that can identify and authenticate an integrated circuit. The timing delay of a path within an integrated circuit is typically a function of the manufacturing process, supply voltage and temperature. The delay itself cannot be usefully employed in a PUF but the ratio of one delay path to another delay path can be employed as they will tend to both vary in the same manner. Techniques such as simple power analysis (SPA) and differential power analysis (DPA) are not very useful in revealing precise timing information of individual delay paths and therefore not a very useful tool in attacking a device where information is contained within a PUF. Reverse engineering methods such as probing are also ineffective against a PUF as described in this report as probing even a single wire is difficult without significantly affecting the delay through that wire.

In WO 2007/119190 it is claimed that memory cells in a static ram power up in a pre-defined random state as a result of manufacturing variations in the individual cells. This method requires both voltage and temperature control of the integrated circuit, not a method that may be employed in many applications. A similar PUF is claimed in WO 2007/116235 where the power-up logic state of memory cells is used. In both cases it may be questioned as to the randomness of the power-up state as other work in the field of data retention in volatile memory indicates that the power-up state of volatile memory cells may be dependent on the previous stored logical state, this effect used to attack a device and determine secret information. This scheme would require that these memory cells were written to and the power-up value periodically refreshed to improve the retention of the logic value when power-down occurred. Further it would be necessary that these reserved memory cells were not used for any other purpose. An attacker may be able by repeated observation of the logic operation of the integrated circuit to determine which cells were used and potentially determine the stored information or may determine the content using a Light Attack—observing the light emissions from the junction area of transistors.

In US provisional patent 2008/0231418 a PUF is created using optical components. In this disclosure a light source shines light into a coating covering an integrated circuit, the coating containing light scattering particles, the integrated circuit containing multiple light sensors. The random nature of the particles in the coating allows the formation of an optical PUF based on the detection of light. This PUF may be useful in rendering the integrated circuit immune to reverse engineering attacks due to the destructive nature of the reverse engineering process. However, the method requires a light source device to be placed on the integrated circuit, possibly with other optical components making the method unsuited to low cost manufacturing.

At best, the PUF is a means to add a chip identifier, that can be used as part of the authentication process: it is not strong enough to act as a key in its own right, and even if used as a key, has to be transformed from a number derived from physical hardware parameters, such as voltage differences, resistor differences or capacitor differences, into a specific number that is the intended key. That transformation process itself is open to attack.

The present invention is a method that overcomes these problem, in that it can produce any key from any set of input parameters, including combinations of parameters such as biometric tag set, PIN code, and a device specific structure or PUF by using encoding that is particularly difficult to reverse engineer or discover, even if the method and circuitry is published and the attacker has access to an FIB machine.

A mathematic basis for the encryption used by the present invention was described by S. Micali and L. Reyzin in a paper “Physically Observable Cryptography”, published by MIT Computer Intelligence Laboratory, November 2003 as mathematical basis for completely secure encryption in the time domain, but without any means or indication how the encryption my be realised. Micali and Reyzin claim the encryption in time, by closing what in engineering terms is the clock-data eye diagram produces a completely secure form of encryption. The present invention is a means of realising that theoretical basis for securing sensitive data on a device, such as a smart card.

### OBJECT OF THE PRESENT INVENTION

It is a primary objective of the present invention to improve the security of a key or other sensitive data by encrypting the key using random-like timing information, the properties of the random timing information determined from unrelated parameters such as a personal identification number or biometric data or device specific structure or unclonable structure, or PIN code, combination thereof.

It is a further objective of the present invention to render the device resistant to tampering by using structures that effectively scramble the decryption or transformation of the data if the device is tampered with.

It is a further objective of the present invention to allow structures to cover large areas or diverse areas, such that so called Light Attacks on the device, or probing of the device, causing corruption of the transformation or decryption of data in the device.

### BRIEF SUMMARY OF THE INVENTION

The present invention exploits a mathematical translation of data from a representation of logic-1's and logic-0's with a clock of regular period, to a series of logic-1's and logic-0's with an irregular sampling clock that has predefined intervals which appear random to an observer. For example the timing diagram shown in FIG. 2 shows a serial data stream DIN sampled by a synchronous clock CLKₛ the sampling process producing an output sequence DOUTₛ 1010, CLKₛ sampling data DIN at clock periods S1, S2, S3 and S4. The use of a non-periodic clock CLK_{R} with the same input data DIN is shown to produce the output data DOUT_{R} sequence 1 0 01, by clock periods S1, S2a, S2b and S3 where S2a and S2b means there are two clock samples in the second clock period. Other sample intervals of the same data can produce any number from 0000 to 1111: that is the data field itself has zero information content. Similarly the clock or timing on its own has zero information content. Where both fields appear random, a precise syncrhonisation in time sampling both clock and data is needed to reveal the information in the clock-data pair. The clock may be designed to have more than one clock interval of apparent jitter, making normal observation of the information impossible without fore-knowledge of both the data and clock in time, with a very high degree of precision.

Any first digital sequence that is clocked by a first regular clock sequence can be transformed into a second digital sequence equivalent to the first digital sequence with no loss of information, clocked by a second irregularly timed clock sequence. The second digital sequence may contain zero information on its own pertaining to the length, content or nature of the first sequence, and the timing sequence may contain zero information on the content or nature of the first sequence but does contain the length (as the number of clock events). The present invention develops and refines the practical application of this basic mathematic translation developed and refined for security purposes.

The present invention relates to a technique and methods to improve the security of a key held in the memory of a device required to be secured whereby the key is encrypted using timing information that is related to a personal identification number (PIN) or biometric data or PUF value or other parameter unrelated numerically to the key such that an observer cannot readily determine the key. In the encryption process the key is sampled with an irregular clock, the number of data bits so produced by the irregular sampling clock in the encrypted key larger than the number of data bits in the un-encrypted key. The irregular timing associated with the sampling of the un-encrypted key is such that the data eye diagram, if observed, would be closed making decryption of the data difficult without knowledge of the timing information. The key is recovered for use in the device required to be secured by a second sampling process whereby any modification of the clock supplied to the device would cause the decryption time transitions to be disrupted allowing detection of an attack and halting of the secure operating mode.

The setup and hold time characteristics of a device are easily disturbed, and this can be exploited in the present invention by arranging the hardware such that the clock has a narrow clock-data eye opening when the timing key is available, tampering with the device such as using Kelvin ATM probes will generally disturb the timing relationship and scramble the key. The present invention may also be used in conjunction with co-pending applications that cause the clock-date eye opening to appear to be closed.

### BRIEF DESCRIPTION OF THE SEVERAL VIEWS OF THE DRAWINGS

For a better understanding of the present invention and the advantages thereof and to show how the same may be carried into effect, reference will now be made, by way of example, without loss of generality to the accompanying drawings in which:

FIG. 1 shows a diagram of a prior art system where a key issuer stores secret information in a memory for use by a processor.

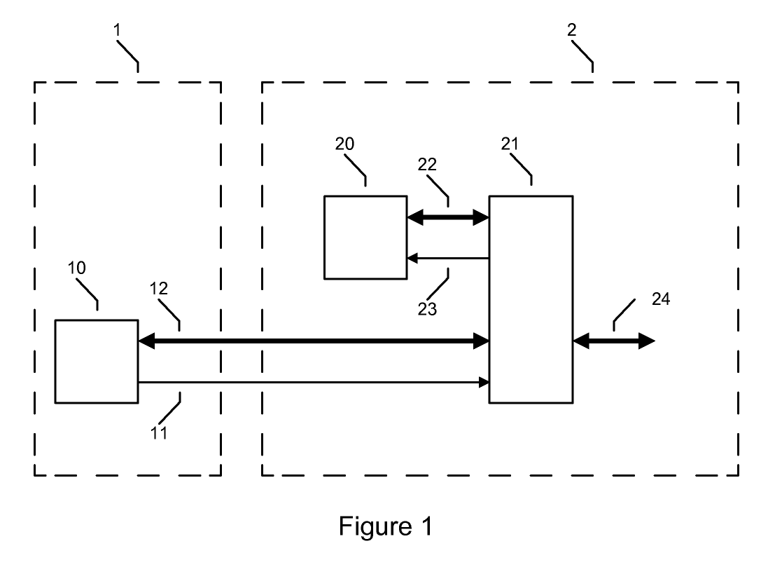

FIG. 2 shows a timing diagram showing regular and irregular clock sampling of data producing different data patterns from the same input pattern.

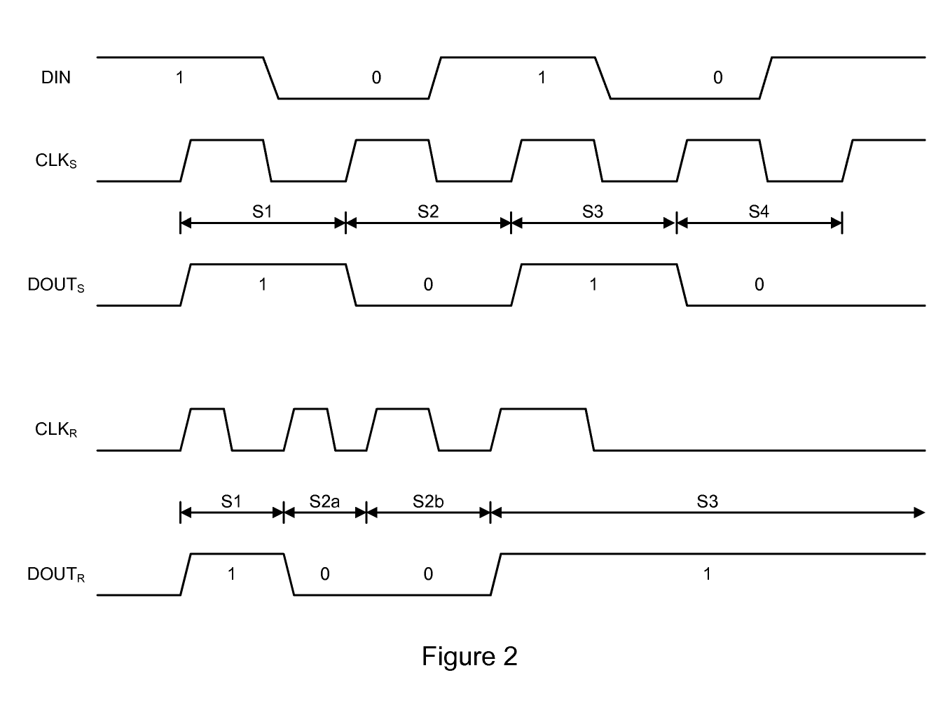

FIG. 3 shows a diagram of one embodiment the present invention where an issuer of the key stores secret information in a memory for use by a processor, the secret information encrypted when written into the memory and decrypted when read from the memory.

FIG. 4 shows a timing diagram of a clock with irregular period.

FIG. 5 shows a timing diagram of the encryption process in the present invention.

FIG. 6 shows a diagram of the encryption device in the present invention.

FIG. 7 shows a diagram of the encryption clock generator in the present invention.

FIG. 8 shows a diagram of the delay line in the present invention.

FIG. 9 shows a diagram of the output gating and clock reconstruction circuit in the present invention.

FIG. 10 shows a timing diagram of a timing issue.

FIG. 11a shows a timing diagram with the sampling timing at one extreme limit illustrating the solution to the timing issue.

FIG. 11b shows a timing diagram with the sampling timing at the other extreme limit illustrating the solution to the timing issue.

FIG. 12 shows a diagram of the preferred embodiment of the overflow counter in the present invention.

FIG. 13 shows a timing diagram of the encryption and decryption process in the present invention.

FIG. 14 shows a diagram of the encryption sampler in the present invention.

### DETAILED DESCRIPTION OF THE INVENTION

In the preferred embodiment of the present invention a cryptographic key is stored in the memory of an integrated circuit such as a circuit on a smart card, the cryptographic key is encrypted with timing parameters derived from a security key enhancing the security of the smart card. The security key may be, for example, a personal identification number, a set of tags derived from biometric data, or the output from a device of specific or non-cloneable structure. The cryptographic key in the present invention is itself not stored in the integrated circuit but is encrypted by the smart card issuer, typically a bank, prior to issuance of the smart card. The encryption process uses an irregular clock to sample the cryptographic key data, in the preferred embodiment, bit-by bit in a serial manner and expanding the number of data bits by the ratio of the average frequency encryption clock to the frequency of the input clock, that is, the system clock. A circuit that uses data from the security key circuit is used to encrypt the cryptographic key in the first instance and decrypt the encrypted cryptographic key on subsequent occasions when needed.

As a generality the disclosure of the present invention will refer to rising edge clock transitions but it is clear that such logic systems can employ operate on falling edge clock transitions or both rising and falling clock edge transitions as the main source of timing events.

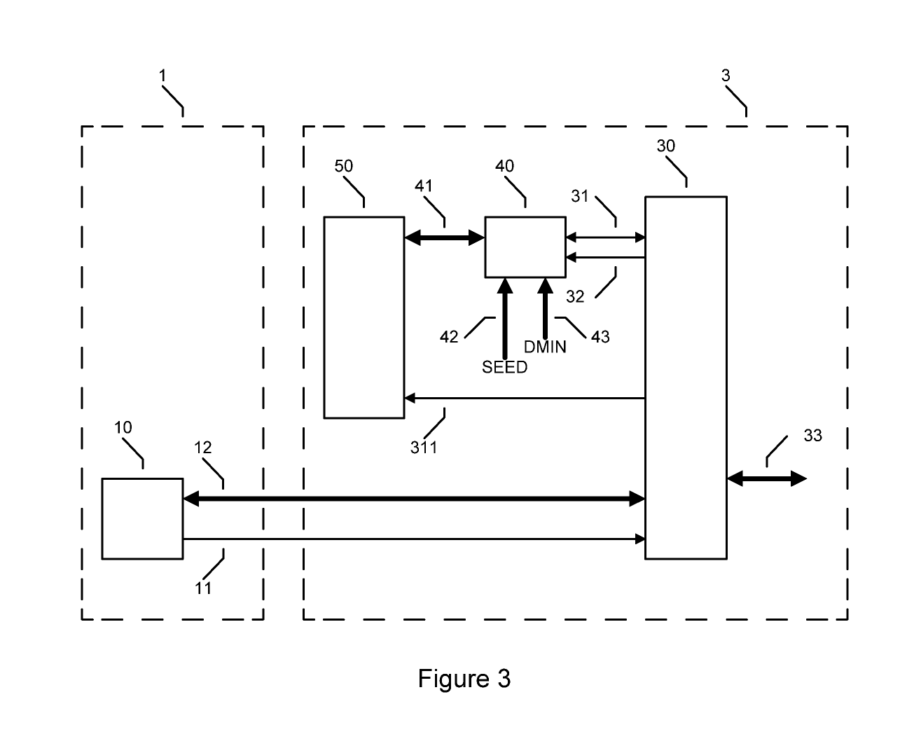

FIG. 3 shows a diagram of a system in which a key is to be stored in an encrypted form and comprises terminal 1, transmitting a key to device 3 across bus 12, the data in bus 12 synchronous to a system clock 11. A key is sent from the key issuer hardware 10 to device 3, for example an integrated circuit in a smart card, at the premises of terminal 1, which is in this instance in a secure environment. The key is encrypted by device 3 and, once encrypted, saved in memory 50. The means of encryption is linked to a personal identification number or a set of biometric data. In the preferred embodiment of the present invention device 3 comprises processor 30 that receives commands and data over bus 12 synchronised to system clock 11. Processor 30 on receiving a command to encrypt the key takes the key data, typically sent immediately following the encryption command, and passes the data through the key encryption device 40 on key data bus 31 with synchronous clock 32. Encryption device 40 encrypts the data on bus 31 and passes the data to memory 50 across bus 41. When processor 30 requires access to the key, for example when encrypting data to be sent back to terminal 1, the data is read from memory 50 and passes through a decryption process in encryption device 40 providing the data to processor 30 on bus 31. Thus the data stored in memory 50 is not the key but an encrypted version of the key.

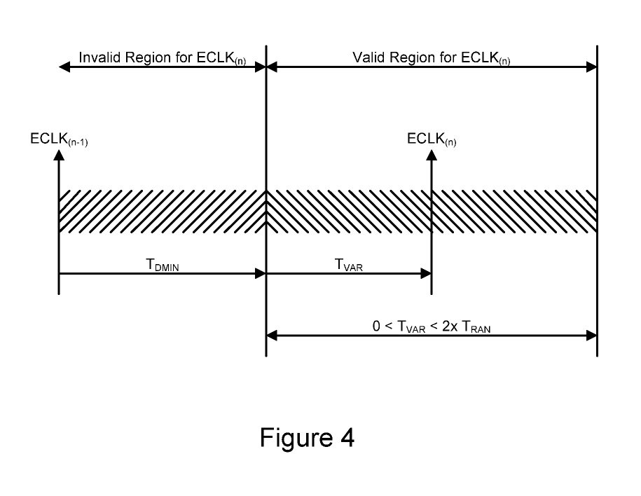

Encryption device 40 comprises a means of encrypting a key sampling the key with a clock that contains an irregular timing property wherein the clock period comprises, in sum, a fixed period and a variable period. FIG. 4 shows a timing diagram of the encryption clock period produced within encryption device 40 where the time from the current output clock transition to the next output clock transition comprises a fixed period T_{DMIN} and an irregular period T_{VAR}. In this example the irregular period T_{VAR} is limited to the range 0<T_{VAR}<2*T_{RAN} where T_{RAN} is an irregular, random, or pseudo random delay time making the nominal period T_{DMIN}+T_{RAN}. The digital parameter DMIN is associated with the fixed period T_{DMIN} while the variable RAN is associated with the variable period T_{RAN}. The time between adjacent clock pulses can be written as:

T_{ECLK(n)}=T_{DMIN}+T_{VAR(n)} (1)

Accordingly the encryption clock may be built from an accumulative process where the time to the next transition is calculated in accordance with the above equation.

In the preferred embodiment of the present invention the encryption clock produced by encryption device 40 is based on a delay line and a logic function which performs the time delay calculation and accumulation process necessary to compute the time to the next transition. This approach has the benefit over a ring oscillator approach in that timing errors due to noise in the delay line of the ring oscillator do not accumulate and cause the irregular clock generator to encrypt the key incorrectly.

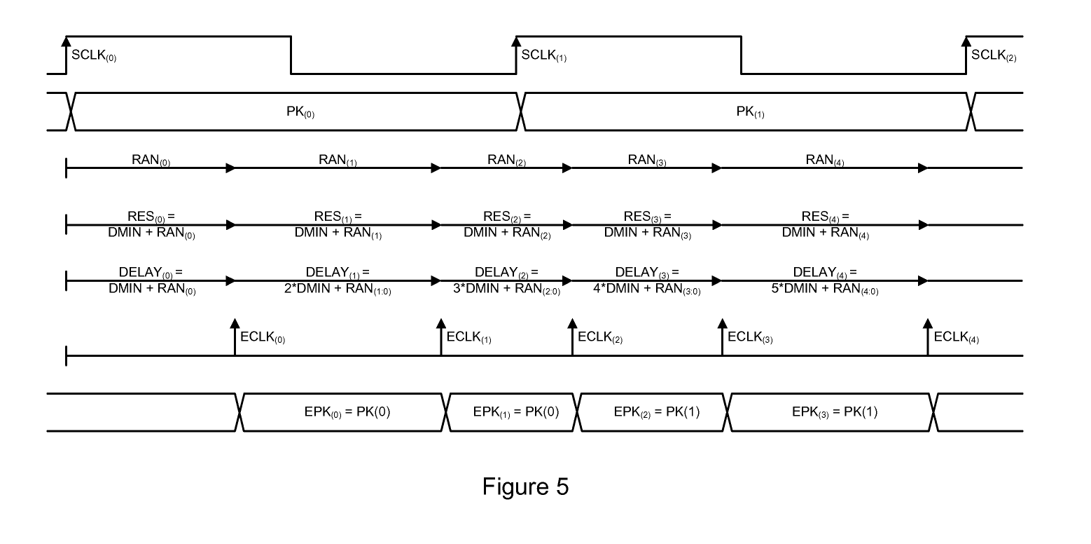

FIG. 5 shows a timing diagram of the encryption process where SCLK₍ᵢ₎ is the system clock 32 used by encryption device 40 and may be derived from clock 11 produced by terminal 1, PK₍ᵢ₎ is the i^{th} bit of the key, the key encrypted bit by bit in a serial manner, RAN₍ⱼ₎ the output of a pseudo random number generator, RES₍ⱼ₎ the output of an adder summing the pseudo random number generator RAN₍ⱼ₎ and the parameter DMIN, DELAY₍ⱼ₎ is the accumulated delay relative to the first system clock transition SCLK₍₀₎, ECLK₍ⱼ₎ is the encryption clock produced by the encryption device 40 and EPK₍ⱼ₎ is the encrypted key. In this last description the index i is used to denote the i^{th} cycle of the key and system clock while the index j is used to denote the j^{th} cycle of the encryption clock and associated buses and signals where, at any point in time, i>j apart from the first cycle, the encrypted key thus containing more data bits than the un-encrypted key. The ratio of the number of encrypted key data bits to the un-encrypted key data bits is defined as the over-sampling ratio. As memory space may be limited in some applications it may be necessary to limit the maximum value of the over-sampling ratio. Additionally, it is necessary that encryption device 40 samples each bit of the key at least once per bit. By means of an example the selection of parameters affecting the over-sampling ratio is now discussed.

The timing of a logic system may be defined with periods of time represented by arbitrary delay units. In the present invention the system clock period may be defined as, for example, T_{SCLK}=4096 delay units. In the irregular clock generator of encryption device 40 the time to the next clock transition is based on the time of the current clock transition, the time to the next transition the sum of the output of a pseudo random number generator with a 12-bit value 0<T_{RAN}<4095 delay units and the T_{DMIN} parameter.

The parameter T_{DMIN} is defined as the maximum propagation delay in the pseudo random clock generator logic and ensures that there is a minimum spacing between the output transitions of the pseudo random clock generator. This parameter may be set to, for example, T_{DMIN}=128 delay units. These parameters result in the time between adjacent transitions of the encryption clock generator T_{RES} to be written as:

T_{RES(n)}=T_{DMIN}+T_{RAN(n)} (2)
T_{RAN(avg)}=0, T_{DMIN}=128 giving T_{RES(avg)}=128 with 32× encryption clock generator transitions per system clock period
T_{RAN(avg)}=2048, T_{DMIN}=128 giving T_{RES(avg)}=2176 with 1.88× encryption clock generator transitions per system clock period
T_{RAN(avg)}=4095, T_{DMIN}=128 giving T_{RES(avg)}=4223 with 0.97× encryption clock generator transitions per system clock period

Clearly, with these parameters, at one extreme where the pseudo random number generator produces a large quantity of small numbers during the encryption process then there will be a large over-sampling factor. At the other extreme the where the pseudo random number generator produces a large quantity of larger numbers during the encryption process or even a single number at the very extreme limit, the above parameters would not guarantee more than one encryption clock for each input bit of the key i.e. information would be lost during the encryption process.

One way to reduce the possibility of both of these effects happening is to create a lower limit and an upper limit for the numbers produced by the pseudo random number generator. The pseudo random number generator would include a masking function to limit the maximum number produced. One method would be to add a logic AND-gate to each output bit of the pseudo random number generator where one bit of the mask field would be one input to the logic AND-gate and the corresponding output bit of the pseudo random number generator would be the second input to the logic AND-gate, the output of each logic AND-gate forming the corresponding output bit of the pseudo random number generator output bus. For example, if the mask field contained logic-1 values in each bit position then the output of the pseudo random number generator would pass directly to the output without being limited. If the most significant two bits of the mask field were set to logic-0 then the top two output bits would always be logic-0 and the pseudo random number so produced limited to a maximum value of 1023. It should be noted that this does not take into account the value of DMIN. This only solves one part of the problem and provides an upper limit for the pseudo random number generator output. To limit the minimum value of the pseudo random number generator output it is a simple matter of adding that minimum value to the output of the pseudo random number generator. In one embodiment the mask field could be used to set the lower and upper limits. For example, consider the case where we had a 12-bit output from the pseudo random number generator having a minimum value of 0 and a maximum value of 4095. If we wanted to limit the minimum and maximum value to a range of approximately ¼ of the maximum we could set MASK=(00111111111)₂ and also set DMIN=MASK. In this case RES would be limited to a minimum value of 1023 and a maximum value of 2046. With these values, T_{SCLK}=4096 delay units then we would get:
T_{RAN(min)}=0, T_{DMIN}=1023 giving T_{RES(min)}=1023, 4.00× encryption clock generator transitions per system clock period
T_{RAN(avg)}=1535, T_{OWN}=1023 giving T_{RES(avg)}=1535, 2.67× encryption clock generator transitions per system clock period
T_{RAN(max)}=2046, T_{DMIN}=1023 giving T_{RES(max)}=2046, 2.00× encryption clock generator transitions per system clock period

With these values it is unlikely that the number of bits in the encrypted key would exceed the memory available if the memory available were 4× the number of bits in the un-encrypted key. Further there would always be at least two encryption clock transitions for each data bit of the un-encrypted key.

In one embodiment of the present invention a key is transferred serially from terminal 1 across bus 12 the data synchronous to system clock 11 where processor 30 receives the key and routes it to key encryption engine 40 on bus 31 synchronous to clock 32 which may be essentially the same clock as system clock 11. In another embodiment of the present invention terminal 1 may communication with device 3 using a data bus with more than one data signal and in such a system it is preferable that the key received by processor 30 is converted into a serial data stream for encryption by encryption device 40.

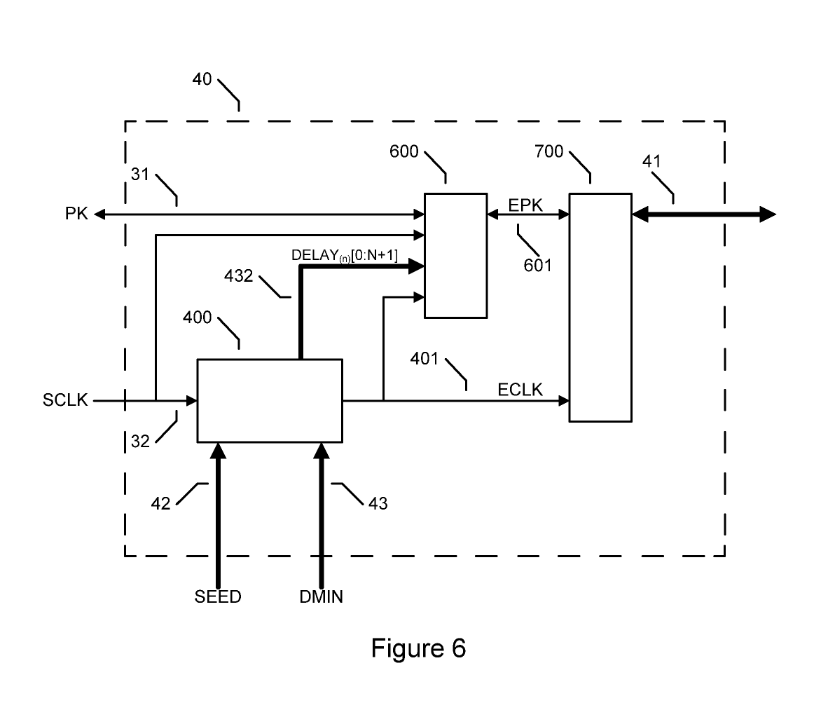

FIG. 6 shows encryption device 40 comprising: encryption clock generator 400 generating encryption clock ECLK 401 based on encryption clock generator inputs SEED 42 and DMIN 43, SEED 42 being a parameter related to, for example, a personal identification number or a set of biometric data, DMIN 43 being a parameter related to the maximum operating frequency of encryption clock generator 400. Clock ECLK 401 produced by encryption clock generator 400 is used by encryption sampler 600 sampling each key data PK 31 at least once per system clock period SCLK 32 producing output signal 601 synchronous to encryption clock ECLK 401. Data packer 700 converts a plurality of serially sampled data bits in signal 601 into data words and control signals 41 suitable for writing into memory 50. Other logic required to interface to memory 50 is application specific and obvious to someone practiced in the art.

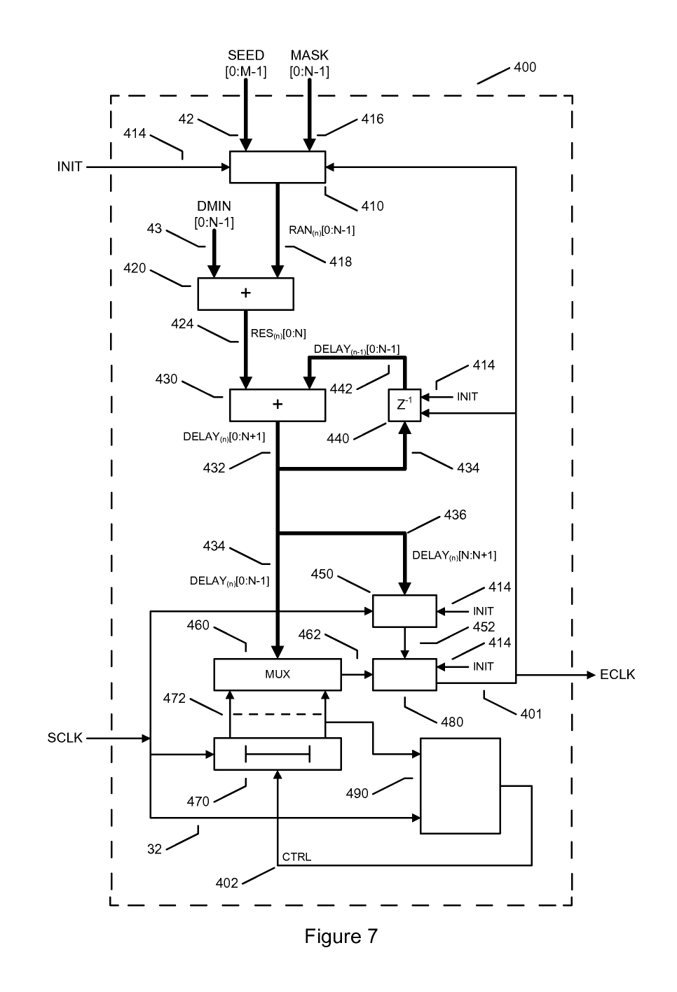

FIG. 7 shows the preferred embodiment of encryption clock generator 400 in the present invention generating timing as shown in FIG. 5 and FIG. 6 comprising: system clock input signal SCLK 32; a pseudo random number generator 410; first digital adder 420; second digital adder 430; digital delay 440; delay line 470; delay line control signal 402; multiplexer 460; logic block 480; overflow counter 450 and output clock, ECLK, 401. Other inputs to the circuit in FIG. 7 are described in the following paragraphs.

Pseudo random number generator 410 comprises: a first input signal ECLK 401 to clock and advance the circuit from one random value to the next random value; a second input signal 414 to initialise the circuit to a known state relative to the system clock for applications where synchronism is required to a third-party circuit using random seed bus SEED[0:M−1] 42; a further input MASK[0:N−1] 416 that operates on the random number generated by the circuit masking one or more bits, forcing bits to zero, limiting the magnitude of the output of the circuit, the pseudo random number generator 410 thereby producing a N-bit random number RAN₍ₙ₎[0:N−1] on bus 418 where the subscript “n” denotes the n^{th} output clock edge. In one embodiment pseudo random number generator is implemented as a maximal length linear feedback shift register with at least M DFF's, M greater than or equal to N, and a number of exclusive-OR logic gates. The DFF's have a set or reset input that is controlled by initialisation signal 414, initialisation signal 414 may be synchronised to the system clock input SCLK 32, placing the DFF's into a known state prior to start of operation. The DFF's may additionally be controlled by the random seed input bus 42, each bit of bus 42 forcing the corresponding DFF into the same logic state. Output bus RAN₍ₙ₎[0:N−1] 418 contains N bits, where N may or may not be different to the number of bits M in bus SEED[0:M−1] 42, each bit taken from different DFF outputs, passing through a logic AND gate and gated with bits of mask bus MASK[0:N−1] 416. Bits in mask input bus 416 are set to logic-0 to force the corresponding bit of the DFF to a logic-0 state and provide a means of limiting the magnitude of the random number generated in bus RAN₍ₙ₎[0:N−1] 418.

Other forms of irregular, pseudo random or indeed truly random number generators may be used for pseudo random number generator 410, for example a white noise source in a device may be employed to produce random time events.

First digital adder 420 determines the relative delay time to the next output clock edge, the delay time consisting of a variable part and a fixed part, and comprises: a first input bus RAN₍ₙ₎[0:N−1] 418 from pseudo random number generator 410 representing the random part of the delay time to the next output clock edge; a second input bus DMIN[0:N−1] 43 representing the fixed part of the delay time to the next output random edge, wherein the values of first input bus 418 and second input bus 43 are added together to form output bus RES₍ₙ₎[0:N] 424, the magnitude of which represents the relative delay time to the next output clock edge. First adder output bus 424 contains one bit more than the larger of the two input buses 418 and 43.

Second digital adder 430 determines which tap of delay line 470 is to be selected to produce the next output clock transition, that is, second adder 430 determines the time of the next output clock transition relative to the current output transition. The lower N bits of second adder 430 output bus DELAY₍ₙ₎[0:N+1] 432 have the same delay modulus as delay line 470. Second adder 430 may produce delay values in excess of N bits due to the accumulation process and the top two bits of second adder output bus 432 may be considered as representing the number of system clock periods that must elapse before the pulse selected by the lower N bits is allowed to be used to reconstitute the output clock ECLK 401. Second adder 430 combines with digital delay 440 to constitute an accumulator where the lower N bits are accumulated every output clock. Second adder 430 has a first input bus RES₍ₙ₎[0:N] 424, connected to the output of first adder 420, a second input bus DELAY₍ₙ₋₁₎[0:N-1] 442 connected to the output of digital delay 440 and an output bus DELAY₍ₙ₎[0:N+1] 432. Digital delay 440 comprises N DFF's connected to form a register with a first input bus DELAY_{(n)[}0:N−1] 434, a clock input signal connected to the random clock generator output clock ECLK 401, an initialisation input signal 414 and an output bus DELAY₍ₙ₋₁₎[0:N−1] 442. The lower N bits of second adder output bus DELAY₍ₙ₎[0:N+1] 432 form digital delay input bus DELAY₍ₙ₎[0:N−1] 434 each bit connecting to a DFF input, the output of each DFF creating digital delay output bus DELAY₍ₙ₋₁₎[0:N−1] 442, each DFF's being, for example, reset by initialisation signal 414 and clock ECLK 401 connecting to the clock input of each DFF effecting a transfer from input bus DELAY₍ₙ₎[0:N−1] 434 to output bus DELAY₍ₙ₋₁₎[0:N−1] 442 on a clock edge transition.

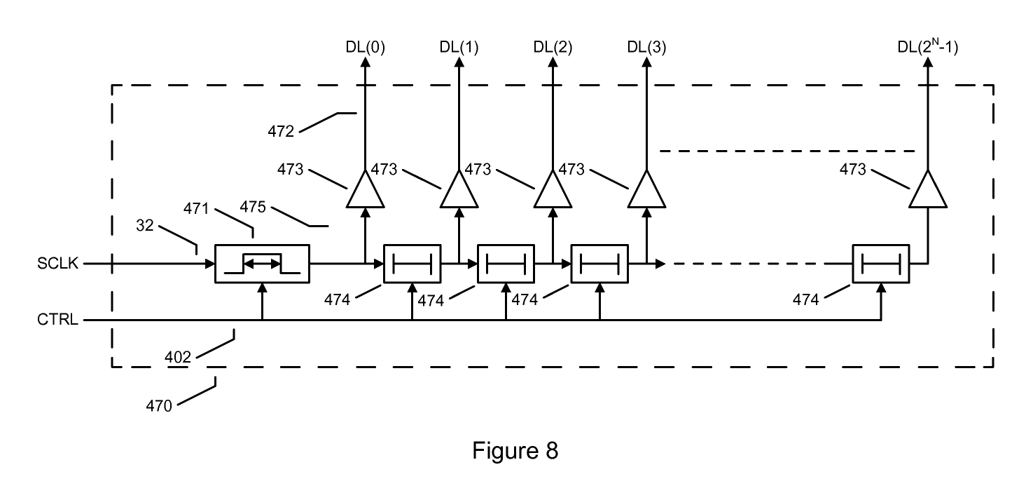

Delay line 470 in a preferred embodiment shown in FIG. 8 comprises monostable 471, a plurality of preferably identical delay cells 474, preferably 2^{N}−1 delay cells, and a plurality of output buffers 473, one output buffer for each delay line tap. Clock input SCLK 32 connects to the monostable input where the monostable produces an output pulse of pre-determined width from, for example, each rising edge of the system clock SCLK 32, the monostable output pulse width preferably less than the maximum propagation delay DMIN in the synchronous logic. In one embodiment the monostable pulse width is controlled by control input CTRL 402, where control input CTRL 402 maintains the monostable pulse width constant over one or more parameters of process, voltage or temperature. The output of monostable 471 connects to the input of a first delay cell 474, the output of the first delay cell 474 connecting to the input of second delay cell 474, the output of the second delay cell 474 connecting to the input of a third delay cell 474 and so forth till all delay cells are connected in a serial manner ensuring delay monotonicity. The output of monostable 471 and the outputs of delay cells 474 are each connected to individual output buffers 473, the outputs of the output buffers 473 forming the delay line output bus 472. In one embodiment the delay of all delay cells is controlled by control input CTRL 402, where control input CTRL 402 maintains the monostable pulse width constant over one or more parameters of process, voltage or temperature. Delay line 470 thereby produces a plurality of output pulses 472 from, for example, the rising edge of system clock input SCLK 32, output pulses being separated in time by, preferably, nominally equal time periods the number of output pulses preferably equal to 2^{N}.

System clock input SCLK 32 is preferably generated by a stable oscillator and preferably also linked to control voltage CTRL 402 for reasons of accuracy maintaining the delay per stage of delay line 470 and the accumulative delay from the system clock input SCLK 32 to the final output of delay line 470 constant.

Multiplexer 460 comprises a first input bus DELAY₍ₙ₎[0:N−1] 434 and a second input bus 472, the first input bus DELAY₍ₙ₎[0:N−1] 434 controlling selection of one signal from second input bus 472, in effect selecting one bit from 2^{N} bits of second input bus 472, the second input bus 472 comprising pulses delayed in time with respect to the system input clock SCLK 32 and producing output signal 462. Means to implement multiplexer 460 are well known to someone practiced in the art and would include, for example but without limitation, a logic decoder of N-lines to 2^{N}-lines and tree of transmission gates. Other means to produce a delay line and means of selecting a delayed signal from the delay line are well known to those practiced in the art and should be considered within the spirit of the invention.

In the preferred embodiment of the present invention, to improve the accuracy of the timing of clock edge transitions, a delay locked loop is formed comprising delay line 470 and phase detector, charge pump and loop filter 490. SCLK 32 is input to delay line 470 and delay line 470 delays SCLK 32 producing an output from the last delay stage of delay line 470, the most significant signal in bus 472. Clock SCLK 32 and delay line output most significant signal in bus 472 are inputs to phase detector, charge pump and loop filter 490, where the loop filter produces control signal 402 to modify and maintain the delay of delay line 470 to the period of SCLK 32. The art of delay locked loops is well known to those practiced in the art and it is recognised that other implementations are possible within the spirit of the invention.

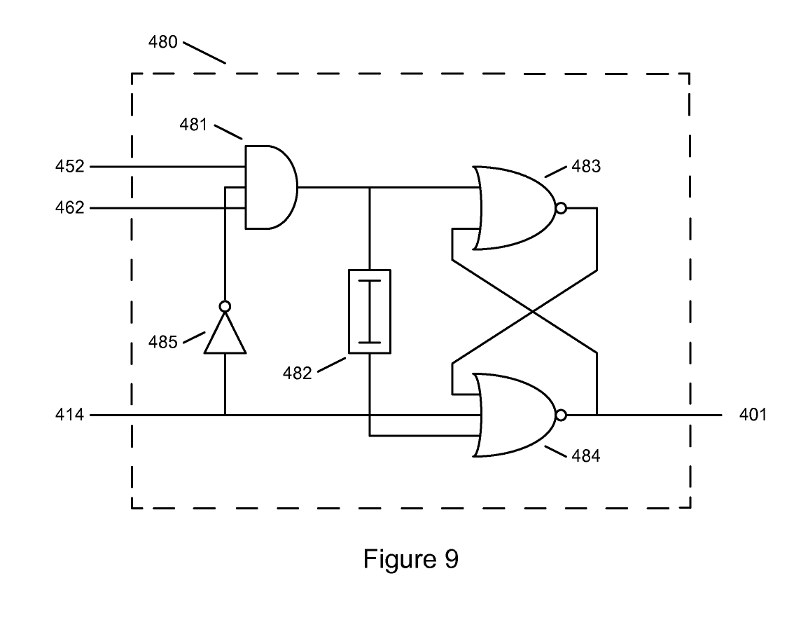

The function of logic block 480 is that of a monostable with an enable input signal and reset input signal. The monostable produces an output pulse in response to a pulse on signal 462 when the output enable signal 452 is active and the initialisation signal inactive. The monostable output is reset when the initialisation signal is active. It is clear that the function of logic block could be produced by a number of means and FIG. 9 shows one embodiment of logic block 480 comprising logic AND gate 481, delay cell 482, a latch formed by logic NOR gates 483 and 484 and inverter 485 providing the local inversion of initialisation signal 414. Logic block 480 performs a gating function with logic AND gate 481 disabling the passage of pulses from multiplexer 460 on input signal 462 when either second input signal 452 is logic-0 or the output of logic inverter gate 485 is logic-0, corresponding to the initialisation signal 414 being logic-1. When conditions are such that logic AND gate 481 passes a pulse from first input signal 462 the set-reset latch formed by delay cell 482 and logic NOR gates 483 and 484 produces a pulse on the output ECLK 401 of width determined predominantly by delay cell 482. The output is initialised by initialisation signal 414 that when placed in the logic-1 state sets ECLK 401 to a logic-0 state.

The function of overflow counter 450 is to generate an output signal that enables or disables the passage of pulses from multiplexer 460 output signal 462 when an overflow condition has occurred in second adder output bus 432 signified by the non-zero value of the bits in bus DELAY₍ₙ₎[N:N+1] 436. When the bits in bus DELAY₍ₙ₎[N:N+1] 436 are both zero then the output enable signal 452 is logic-1 when either bit in bus DELAY₍ₙ₎[N:N+1] 436 is logic-1 then the output signal 452 is set to logic-0 for a period of time defined by the system clock period multiplied by the value of the overflow bits in bus DELAY₍ₙ₎[N:N+1] 436. In a simplistic embodiment counter 450 comprises a state machine that takes as a first input bus DELAY₍ₙ₎[N:N+1] 436 and executes actions at transitions of the system clock SCLK 32. If the bits in bus DELAY₍ₙ₎[N:N+1] 436 are both logic-0 then the output enable signal 452 is set to logic-1 otherwise the output enable signal 452 is set to logic-0 and the state machine counts down the value presented on the bits in bus DELAY₍ₙ₎[N:N+1] 436 on the rising edge transitions of system clock SCLK 32 delaying the generation of the output enable signal 452 until such time as the value counted down in the state machine reaches zero. Initialisation signal 414 is input to counter 450 to initialise the state machine to a known state on power-up or start-up of encryption clock generator 400.

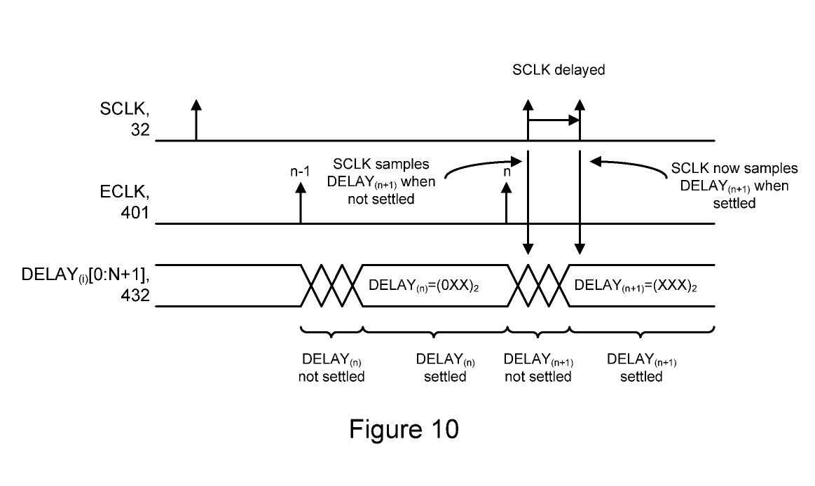

One issue arises in the implementation of overflow counter 450 using of system clock SCLK 32 to sample bus DELAY₍ₙ₎[N:N+1] 436 where it is possible to sample when the data bits in the bus DELAY₍ₙ₎[N:N+1] 436 are not settled. A technique to overcome this issue is now disclosed. First, it is necessary to understand when this issue may arise. Consider the case shown in FIG. 10 where an ECLK 401 transition has been generated in response to second adder output bus DELAY₍ₙ₋ᵢ₎[0:N+1] 432. ECLK 401 advances the pseudo random number generator 410 and the digital delay 440 causing signals to propagate through first adder 420 and second adder 430 forming the new delay value on second adder bus DELAY₍ₙ₎[0:N+1] 432. It can be seen that the next clock transition is going to occur just before SCLK 32. It is then at the generation of the ECLK₍ₙ₎401 transition that the SCLK 432 sampling edge would attempt to sample second adder output bus DELAY₍ₙ₊₁₎[N:N+1] 436 while the data bits were not valid. A technique and method to overcome this issue is proposed whereby the clock sampling overflow data bits DELAY₍ₙ₎[N:N+1] 436 at the state machine input is formed from a delayed clock that ensures that sampling only occurs when the overflow data bits DELAY₍ₙ₎[N:N+1] 436 are settled.

The solution to this problem exists when the propagation path through first adder 420 and second adder 430 is less than the minimum propagation delay T_{DMIN}. It is an implicit condition for operation of encryption clock generator 400 that the propagation path through first adder 420 and second adder 430 is shorter than T_{DMIN}. First it is necessary to determine when this condition will occur and, when imminent, generate a sampling signal active only when the overflow data bits are settled. Detecting the settling error condition is possible by evaluating the value of bus DELAY₍ₙ₎[0:N+1]432. When the value on bus DELAY₍ₙ₎[0:N+1] 432 is within the settling time, T_{SETTLE}, of the next SCLK 32 sampling edge which is the same as being within T_{SETTLE} of a change in the top two most significant bits of then it is necessary to delay SCLK 32 by an amount less than DMIN yet more than the settling time of bus DELAY₍ₙ₎[0:N+1] 432. In a preferred embodiment the sampling signal so generated is a delayed version of encryption clock generator 400 output clock ECLK 401.

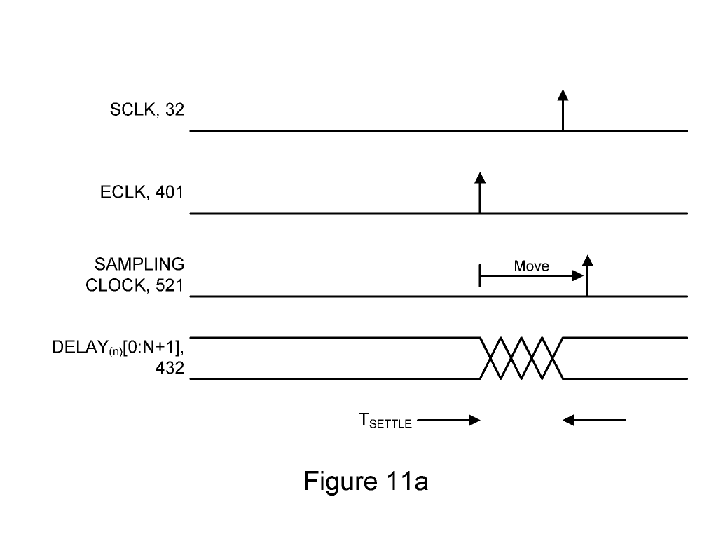

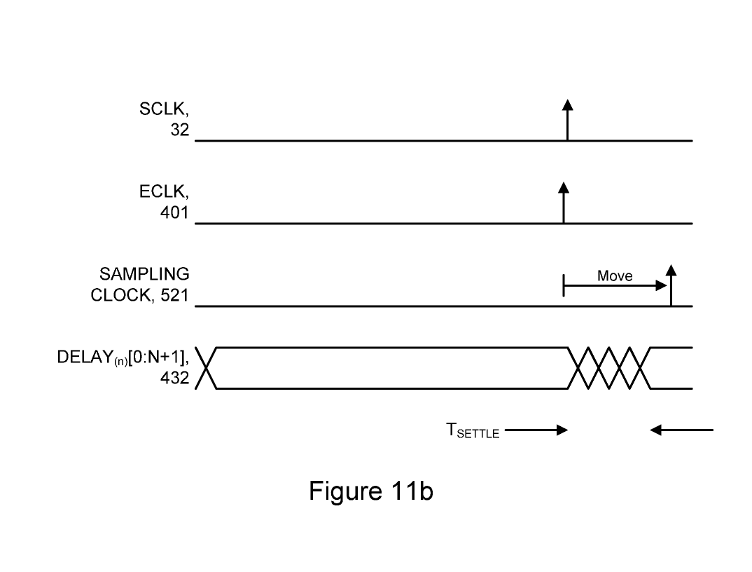

FIG. 11a shows the first extreme case where output clock transition ECLK₍ₙ₎ 401 occurs just before the SCLK 32 sampling transition. In this extreme case only the very minimum delay of SCLK 32 is necessary. Alternatively a sampling clock signal 521 may be generated by ECLK 401 by delaying ECLK 401 by an amount larger than T_{SETTLE} but less than T_{DMIN}.

FIG. 11b shows the last extreme case where output clock transition ECLK₍ₙ₎ 401 occurs almost at the same instant as the SCLK 32 sampling transition. In this extreme case SCLK 32 needs to be delayed by at least T_{SETTLE}. Alternatively a sampling clock signal 521 may be generated by ECLK 401 by delaying ECLK 401 by an amount larger than T_{SETTLE} but less than T_{DMIN}.

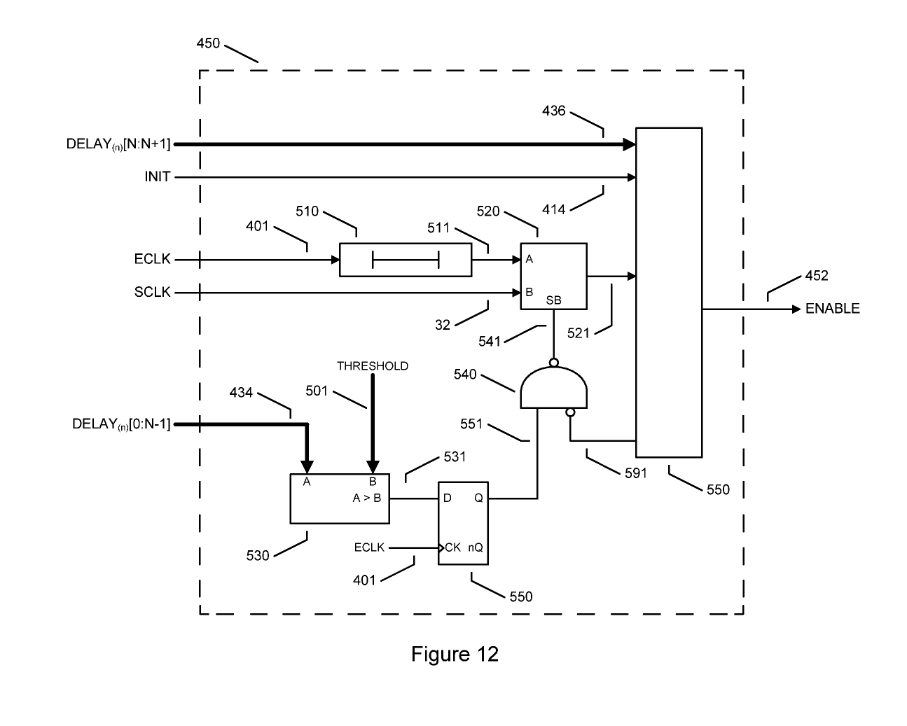

The preferred embodiment of overflow counter 450 is shown in FIG. 12 and comprises: a first clock input SCLK 32; a second clock input ECLK 401; delay line 510 producing output signal 511 a delayed version of second clock input 401, delayed by an amount greater than T_{SETTLE} but less than DMIN, preferably stabilised against time variations in the manner used by other delay lines in the invention; comparator 530 with a first input DELAY₍ₙ₎[0:N−1] 434, a second input bus THRESHOLD 501 producing a logic-1 output 531 when the value from bus DELAY₍ₙ₎[0:N−1] 434 exceeds the value of bus THRESHOLD 501 otherwise producing a logic-0; DFF 550 latching the result of comparator 530 output signal 531 on ECLK 401 transitions and producing output signal 551; logic NAND gate 540 with a first input signal 551, a second, negated, input signal 591 from state machine 550 producing output signal 541 as the logical NAND of the first and negated second input signals; multiplexer 520, said multiplexer selecting a first input, signal 511, or a second input, SCLK 32, depending on the state of third input 541, first input signal 511 selected when the latched comparison result signal 551 is a logic-1 and signal 591 is logic-0 otherwise second input signal SCLK 32 selected and state machine 550 with first inputs DELAY₍ₙ₎[N:N+1] 436, second input Initialise 414, first output 591 that, when a logic-1, controls multiplexer 520 to select SCLK 32 as the clock for the state machine and output 452 to enable the gating or otherwise of the pulses 462 from multiplexer 460 to form output clock ECLK 401.

It is noted that alternative methods are possible within the spirit of the invention including delaying SCLK 32 by an amount equal to the difference between the transition of the lower and upper bits in bus DELAY₍ₙ₎[0:N+1] 432 plus a delay greater than T_{SETTLE} but less than T_{DMIN}. Other implementations of the hardware to delay SCLK 32 will be obvious to someone practiced in the art.

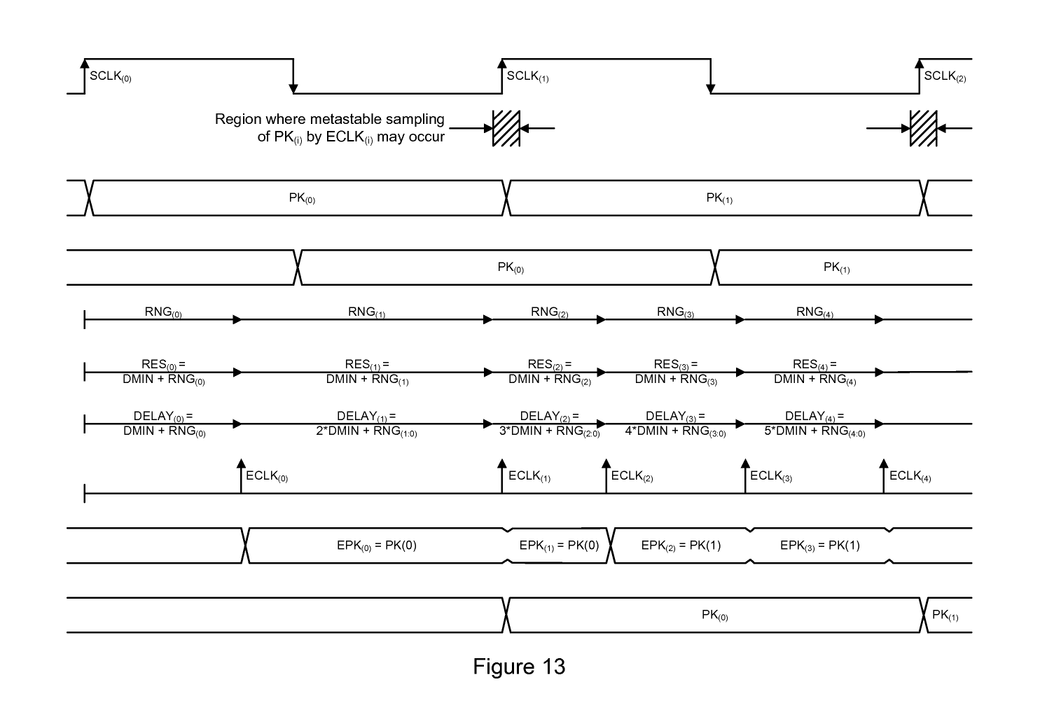

FIG. 13 shows a timing diagram of the encryption process where ECLK₍₁₎ 401 occurs at a time where data PK 31 may not be settled. In such a case EPK 601 could take on either a logic-0 or a logic-1 state. In the decryption process ECLK 401 generates EPK 601 which is then sampled by SCLK 32 producing PK 31, the un-encoded key. It is necessary condition that EPK 601 is stable and valid for correct decryption. In the preferred embodiment of the present invention a means of detecting a potential metastable event that may lead to incorrect decryption is introduced. During the encryption process it is possible to detect when ECLK 401 will be generated in regions where a metastable event may occur in the decryption process. Once a potential metastable event is detected the sampling process during encryption is modified in a controlled manner to ensure that the metastable event does not occur during decryption.

In the majority of sampling events clock ECLK 401 samples data PK 31 at a time where the data is stable and there is no possibility of a metastable event. When a potential metastable event is forecast clock ECLK 401 samples a delayed version of PK 31 which is stable. It is possible to forecast when a potential metastable event occurs as the encryption clock generator tracks time relative to SCLK 32, calculating when the next ECLK 401 transition is to occur. Knowing when the next ECLK 401 transition is going to occur allows remedial action in the case if the next ECLK 401 transition is going to occur at a point in time where there is a possibility of a metastable state being produced by the encryption sampling process. Typically a metastable event will occur when data PK 31 is sampled while it is changing. Data PK 31 is generated by SCLK 32 and, since, in the preferred embodiment of the present invention, there is little loading on the PK 31 signal, it can be stated that data PK 31 changes state at a time close to the time that SCLK 32 transitions. So, by the use of one or more comparators detecting when the next ECLK 401 transition is to occur at a time where data PK 31 may not be stable it is possible to setup a scheme where a delayed version of PK 31 is sampled. In an application where there is a larger load on data PK 31 and there is a larger delay it is possible to account for this by modifying the comparator thresholds. In either case, the comparator thresholds should take into account timing variations due to process, supply voltage and temperature.

In a second embodiment the encryption clock sampling point may be advanced so that the encryption sampling takes place earlier again avoiding the metastable event. This method is applicable where the advancement of the encryption sampling clock does not violate the minimum separation of the encryption clock transitions that is the separation of the encryption clock sampling transitions is still larger than the DMIN timing parameter. This is possible in schemes where the DMIN and MASK parameters have been chosen such that MASK−DMIN is greater than the time period of the metastable region. Such a method may be implemented by the introduction of a subtraction module in the output of second adder 430 modifying DELAY₍ₙ₎[0:N−1] 434, performing no action when no metastable event is detected or subtracting a value equivalent to the necessary encryption clock advance.

It should be noted that the same method of generating ECLK 401 is used in the decryption process following exactly the same logical steps.

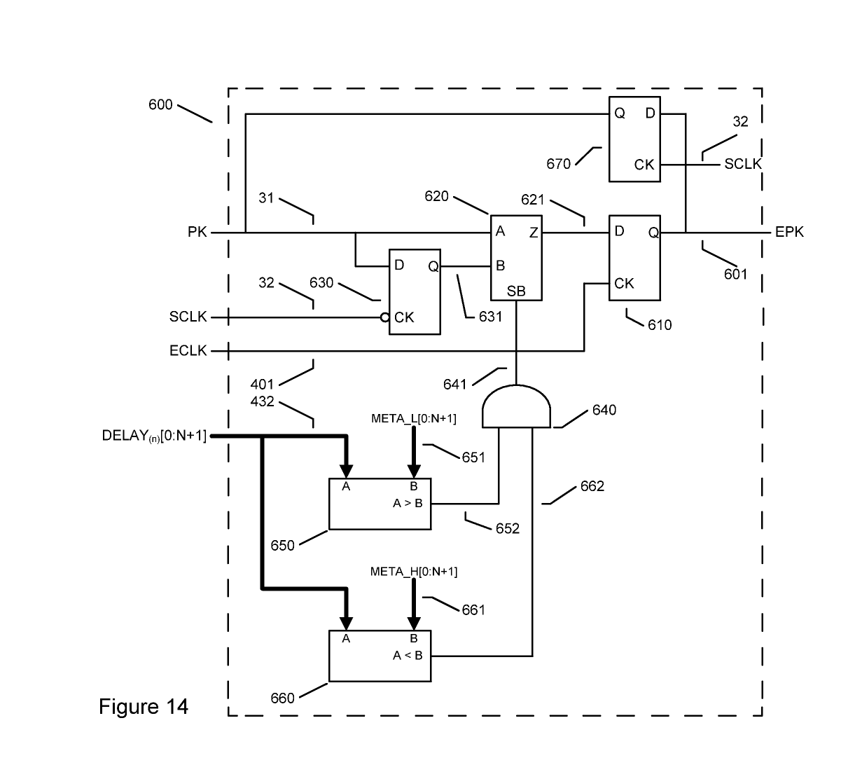

FIG. 14 shows the preferred embodiment of the encryption sampler 600 comprising: first sampler 610; data selector 620; D-type flip-flop 630; first comparator 650; second comparator 660; logic AND gate 640 and second sampler 670. Encryption sampler 600 operates to sample the key in the encryption process producing the encrypted key. Encryption sampler 600 operates to sample the encrypted key in the decryption process producing the original un-encrypted key. In the encryption process sampler 610 samples the key PK 31 with the encryption clock ECLK 401 producing the encrypted key EPK 601. In the decryption process sampler 670 samples the encrypted key with SCLK 32 producing the original un-encrypted key PK 31. The key data line PK 31 is considered bi-directional and means exist to allow the sharing of data on data line PK 31 without conflict between multiple sources attempting to simultaneously drive line. Similarly, the encrypted key line EPK 601 is considered bi-directional and means exist to allow the sharing of data on data line EPK 601 without conflict between multiple sources attempting to simultaneously drive line.

In the encryption process comparator 650 has as first input DELAY₍ₙ₎[0:N+1] 432, the calculated time at which ECLK₍ₙ₎ next transitions, and as second input META_L[0:N+1] 651, a threshold set according to simulation results or calculations, producing an output 652 when the first input exceeds the second input indicating a potential metastable event could occur at the next ECLK 401 sampling event. Comparator 660 has as first input DELAY₍ₙ₎[0:N+1] 432, the calculated time at which ECLK₍ₙ₎ next transitions, and as second input META_L[0:N+1] 661, a threshold set according to simulation results or calculations, producing an output 662 when the second input exceeds the first input indicating a potential metastable event could occur at the next ECLK 401 sampling event. The combination of comparator output signals 652 and 662 forms a window comparator such that when both outputs are true the value of DELAY₍ₙ₎[0:N+1] 432 is forecast to produce a transition at ECLK₍ₙ₎401 which may result in a metastable event. Comparator output signals 652 and 662 are combined with logic AND gate 640 producing output signal 641, where signal 641 controls the selection of PK 31 and a delayed version of PK 31 with data selector 620 providing a data input 621 to sampler 610, a D-type flip-flop. In the preferred embodiment of the present invention a delayed version of PK 31 is produced by SCLK 32 sampling PK 31 on the alternate edge to the normal clocking edge. D-type flip-flop 630 samples data input PK 31 with SCLK 32 on the alternate edge producing output signal 631. Signal PK 31 is a first input to data selector 620, signal 631 is a second input to data selector 620 wherein data selector 620 produces output signal 621 in accordance with the control signal 641, signal 621 the input to sampler 610, a D-type flip-flop, said input signal sampled by ECLK 401 with no possibility of a metastable event at the output of sampler 610.

In the decryption process sampler 670 samples the encrypted key with SCLK 32, data having been pre-fetched from memory 50 to a local buffer and synchronous to ECLK 401.

Data is encrypted and decrypted serially in encryption sampler 600. Data packer 700 is used to convert the serial data stream to parallel data words for writing to memory 50 in the encryption process and conversely convert the parallel data words read from memory 50 to a serial data stream for decryption. For example in the encryption process data packer 700 accepts a serial data stream synchronous to ECLK 401 onto signal EPK 601, converts the serial data stream to 16-bit data words, and writes these data words to memory 50 through a write buffer. Conversely in the decryption process data words are pre-fetched to a read buffer and converter to serial form using ECLK 401 and passed to encryption sampler 600.

Data packer 700 also provides a second function namely to fill the entire space in memory 50 allotted to the encrypted key with random data minimising the amount of information available to an observer which may not be the case were memory 50 only to be filled with the encrypted key data. In the preferred embodiment of the present invention data from pseudo random number generator 310 is used in filling the unused allotted encrypted key space in memory 50. The means of implementing a serial to parallel and parallel to serial conversion schemes and a method to fill the allotted space in memory 50 for the encrypted key are obvious to someone practiced in the art.

The first step in the decryption process is to fetch data from memory 50, where it is assumed for clarity, that the data is stored as 16-bit data words and may be read from memory 50 one word at a time or, indeed one block at a time, a block being multiple words, producing data in the same order as written into memory 50. Due to the asynchronous nature of SCLK 32 and ECLK 401 it is necessary to buffer the data from memory 50, using a local buffer. The encrypted key data is thus read from memory 50 and converted to a serial data stream by data packer 700 using ECLK 401 as the clock for the serial data stream. FIG. 13 shows the serial data stream produced by ECLK 401 and sampled by SCLK 32 generating decrypted key PK 31. The sampling of EPK 601 by SCLK 32 does not result in any metastable events due to the manner in which the metastable issue was handled in encrypting the data in the first instance.

Once the un-encrypted key has been used the registers holding the key are immediately over-written in order to avoid the possibility of the registers retaining data even through a power-down and power-up sequence applied to the integrated circuit.

In sub-micron and deep sub-micron integrated circuit processes it is a requirement that metal fill patterns are included within the layout to aid in the manufacturing process. In a further embodiment of the present invention use is made of these metal patterns to deliberately include capacitance from these patterns in a manner that any change to these patterns will affect the timing of the delay line and thereby the decryption process, whether it is the removal of metal or the addition of metal as part of an attack on the integrated circuit in an attempt to reveal the encryption process timing. The removal of metal may be, for example, part of an attack where reverse engineering is taking place while the addition of metal may be part of an attack where material is added by, for example, a focussed ion-beam machine, to break, reconnect and thereby reconfigure structures within the integrated circuit. Accordingly delay line 470 is formed with intentional metal to metal structures between time-critical nodes and one or more of the following nodes: the supply voltage line; the ground line or other time-critical nodes.

In a further embodiment of the present invention capacitances within delay line 470 are formed with the metal on the rear of the integrated circuit, such metal commonly referred to as rear metalisation or backside metalisation. Rear metalisation is often employed on the rear of an integrated circuit to aid in the connection of the substrate to the ground terminal to provide, for example, a means of minimising the noise injected into the substrate from differential connection of ground and substrate.

The properties of delay line 470 are designed to include structures that couple with the rear metalisation thereby forming one or more capacitors, the capacitance from these capacitors becoming part of the structure of the delay line and thereby inherent to the timing of the encryption and decryption process. Any modification to the rear metalisation, for example, by someone attempting to obtain access to the key after the decryption process, may adversely affect the decryption process and render the decryption process invalid. Similar structures may be used within the timing system described herein such that modification of the conductance of the structure interferes with the timing. These structures may be extensive or cover specific regions, and act as a shield around parts of the device holding sensitive data, protecting that data from Light Attacks (monitoring the light output from transistors), and from probing. The structures may be within, on or at the rear of the device, and may include circuit structures outside the device that should be protected from tampering.

Thus it has been shown a technique and method whereby a key may be stored in an encrypted form, the process of encryption and decryption using timing information from a source of random timing events improving the security of the key by not holding the key in un-encrypted form and only decrypting the key when needed and not storing the key in un-encrypted form once it has been used.

Further a method has been presented whereby a metastable event in the decryption process is identified during the encryption process and remedial action taken to ensure that decryption can take place without the possibility of the metastable event occurring in the decryption process.

The susceptibility of the method of decryption of the encrypted key in the present invention to an attack on the integrated circuit through the introduction of disturbances in the period of the system clock are highly likely to result in improper decryption of the encrypted key thereby enhancing the security of the key.

Yet further the security of the encrypted key against intrusive attacks on the integrated circuit device by the inclusion of capacitive structures in the delay line of the encryption clock generator that, if disturbed or modified by methods employed in the reverse engineering of integrated circuits, such as, for example, probe attacks, atomic force microscopy attacks focussed ion beam cutting or deposition or plasma etching and other reverse engineering methods will result in disturbance of the encryption clock timing and thereby incorrect decryption of the key.

We claim:

1. A device for encrypting/decrypting data based on irregular time sampling, the properties of the irregular time periods determined from a personal identification number or tags derived from biometric data or device specific structure or unclonable structure, or combination thereof, wherein the application of the data encryption process produces encrypted data that when subsequently applied to the decryption process the original data is returned with no loss of information.

2. A device for encrypting/decrypting data according to claim 1 wherein the said device comprises an encrypting module comprising:
a first input clock signal of regular period;
a first digital data input sequence synchronous to the first input clock signal of regular period;
an encryption clock generator producing a second clock of irregular period each period of the second clock of irregular period shorter than the period of the first input clock of regular period;
an encryption sampler transforming the first digital data input sequence into an encrypted output digital data sequence, the encrypted output digital data sequence produced by sampling the first digital data input sequence by the second clock of irregular period each data bit in first digital data input sequence sampled by one or more samples of second clock of irregular period;
an encryption data packer module transforming the output encrypted digital data sequence into a sequence of data words, said data words transferred to a storage device, the encrypted digital data output sequence appended with random data such that the transformed data words fill the allotted storage space, the data words comprising one or more data bits.

3. A device for decrypting data according to claim 1 wherein the said device comprises a decrypting module comprising:
a first input clock signal of regular period;
an encryption clock generator producing a second clock of irregular period each period of the second clock of irregular period shorter than the period of the first input clock of regular period;
a decryption data packer module for reading digital data words from a storage device, the digital data words having been previously encrypted by an encrypting module of claims 1-2, the digital data words of one or more data bits and synchronous to the second clock of irregular period, transformed into a first digital data sequence synchronous to the second clock of irregular period;
a decryption sampler transforming the first digital data sequence into a decrypted digital data output sequence, the decrypted digital data output sequence produced by sampling the first digital data sequence by the first clock input signal of regular period.

4. A device for encrypting/decrypting data according to claim 2 wherein said encryption clock generator produces an output clock of irregular period and comprises:
a first input clock signal of regular period;
a pseudo random number generator producing a data word at each encryption clock generator output clock transition;
a first logic module for calculating the time delay from the current output clock transition to the next output clock transition;
a second logic module converting the time delay value for the next output clock transition from the first logic module into a value that is relative to the input clock, the time delay value possibly extending over more than one period of the input clock;
a delay circuit producing an output pulse delayed in time to the input clock, the time delay variable and controlled through an input control bus;
a third logic module producing an output gating signal in the presence of overflow bits from the delay value output of the second logic module;
an output-gating and clock reconstruction circuit producing an output clock.

5. A device for encrypting/decrypting data according to claim 4 wherein the said pseudo random number generator produces an output data word of more than 1 bit, the value of the output data word representing a delay time of magnitude directly related to the maximum delay duration of the delay circuit and comprises:
a first input data word and a first control signal to initialise said pseudo random number generator with a known starting value;
a first input mask setting one or more pseudo random number generator output bits to zero limiting the magnitude of the value produced by said pseudo random number generator;
a third input intended to halt operation of the pseudo random number generator when said pseudo random number generator needs to be started relative to an external clock or other signal;
a fourth input, which causes the pseudo random number generator to advance from a first number to a second number, said numbers possessing pseudo random characteristics, said random number generator producing an output data word of N data bits, N being an integer greater than 1, said output data word representing a delay time of magnitude directly related to the delay circuit maximum delay duration.

6. A device for encrypting/decrypting data according to claim 4 wherein said first logic module comprises:
a first input data word, said input data word being the output of pseudo random number generator;
a second input data word, the value of said input data word defining the minimum encryption clock generator output clock period;
a first digital adder with a first input connected to said first input data word, a second input connected to said second input data word, said first digital adder generating an output data word equal to the sum of the two input data words, the output data word containing one more data bit than the largest number of data bits in the first input data word or second input data word thus allowing overflow and wherein the value of the output data word of said first digital adder represents the next clock generator period.

7. A device for encrypting/decrypting data according to claim 6 wherein said second logic module produces a first output data word, the overflow data word, and a second output data word, the time delay data word and comprises:
a first input data word, the output data word of the first adder;
a second register with a plurality of state storage elements equal in number to the number of data bits in the pseudo random number generator output data word, said register with a clock input signal, an initialisation input signal, an input data word and an output data word, said clock input signal the clock generator output clock transferring the contents of said input data word to said output data word in a synchronous manner, said initialisation signal resetting the output data word in an asynchronous manner, said input data word the second logic module time delay data output word;
a second adder with a first input connected to the first input data word and second input connected to the second register output data word, said second adder producing an output data word equal to the sum of the two input data words, the output data word containing one more data bit than the largest number of data bits in the two input data words thus allowing overflow, said second adder producing a first output data word, the second logic module overflow data output word, formed from the upper two data bits of second adder output data word and said second adder producing a second output data word, the second logic module time delay data output word, the delay value data word from the remaining bits, equal in number to the number of bits in the pseudo random number generator output data word.

8. A device for encrypting/decrypting data according to claim 4 wherein said delay circuit comprises:
a first input clock signal of regular period;
a first control input signal for controlling the delay of the delay circuit;
a monostable producing an output pulse from a transition of the encryption clock generator input clock, the starting edge of the monostable output pulse with minimal delay relative to the input clock transition that generated the starting edge of the monostable output pulse, the duration of the monostable output pulse determined from delay elements within the monostable, the duration of the monostable output pulse less than the minimum time between encryption clock generator output clock transitions, and an input control signal for maintaining the monostable pulse duration constant against process, voltage and temperature variations;
a delay line comprising a plurality of delay cells, each delay cell with a first input signal, a second input signal and an output signal, said output signal a delayed version of the said input signal, said second input signal connecting to the second input signal of all delay cells controlling the delay duration of each and every delay cell, the first input of the first delay cell connected to the monostable output signal, the output of the first delay cell connected to the first input of the second delay cell, all delay cells connecting in series with the output of each delay cell connecting to the first input of the following delay cell, the outputs of the monostable and all delay cells forming a bus of a given number of output signals, said number equal to the maximum value of the delay line data bus, each output signal unique in providing a pulse delayed in time relative to the encryption clock generator input clock, the time delay from the input clock to the pulse from the last delay cell equal to the clock period of the encryption clock generator input clock;
a multiplexer that selects one of the delay line output signals matching the delay tap to the value in the delay line data bus producing an output pulse indicating where the next encryption clock generator output clock transition may occur dependent on the state of the overflow flow data bits;
a phase detector comprising a first input signal, the encryption clock generator input clock and a second input signal, the delay line final delay cell output signal, said phase detector producing an output control signal related to the difference in phase between said first input signal and second input signal, said phase detector including a filter smoothing said phase detector output control signal and said output control signal adjusting the delay characteristics of the monostable and delay cells of the delay circuit such that said delay circuit produces a time delay equal to the period of the input clock maintaining said time delay constant over process, voltage and temperature variations.

9. A device for encrypting/decrypting data according to claim 4 wherein said third logic module produces an output gating signal comprising:
a sampling clock selection circuit producing as output a clock signal for a finite state machine, said clock advancing the finite state machine from one state to another state and further allowing the sampling of input signals in a manner that does not produce a metastable result;
a finite state machine clocked with the clock from the sampling clock selection circuit, said finite state machine sampling the overflow data bits and, based on the value of said overflow data bits producing output signals to control the sampling clock selection circuit and the output gating and clock reconstruction circuit.

10. A device for encrypting/decrypting data according to claim 9 wherein said sampling clock selection circuit comprises:
a first input clock signal of regular period;
a second clock input, the encryption clock generator output clock of irregular period;
a first data input signal;
a delay line with a first input connected to the second clock input said delay line with a delay period controlled by the delay circuit phase detector, said delay period no more than the minimum period between transitions of the encryption clock generator output clock and no less than the worst-case propagation delay through the first logic module and second logic module;
a multiplexer with a first input connected to the first clock input of irregular period, a second input connected to the output of the delay line, a third input selecting said first input or second input as the multiplexer output signal, said multiplexer output signal the sampling clock selection output clock signal;
a comparator with a first input said delay data bus, a second input from a register, the comparator output true when the value of the first input exceeds the value of the second input;
a D-type flip-flop to latch said comparator output using the second clock, said encryption clock of irregular period;
a logic gate with a first input, a second input and an output said logic gate implementing the logic NAND function, said first input first data input signal a finite state machine output, said second input the output of said D-type flip-flop, said logic gate output signal controlling said multiplexer.

11. A device for encrypting/decrypting data according to claim 9 wherein said finite state machine comprises:
a first input signal to initialise the finite state machine into a known state at power-up or clock generator start-up;
a first clock input signal connected to the output of the sampling clock selection circuit;
a first input data word connected to the overflow data word;
a first output signal, the output gating and clock reconstruction circuit input signal;
a second output signal, the sampling clock selection circuit control signal;
a logic function initialised by said first input signal and executing a fixed algorithm in response to the first clock input signal and first input data word, producing said first finite state machine output signal to indicate when a pulse from the delay circuit may be used to form the next clock generator output clock signal and further producing said finite state machine second output signal when the finite state machine requires to control the sampling clock selection circuit.

12. A device for encrypting/decrypting data according to claim 4 wherein said output-gating and clock reconstruction circuit produces the encryption clock generator output clock of irregular period and comprises:
a first input signal said delay circuit output pulse signal;
a second input signal said output gating signal of the third logic module;
a third input signal said initialisation signal;
a logic gate with a first input signal, a second input signal and a third input signal producing an output signal as the logical AND of the three input signals, said first input signal connected to the output of the delay circuit, said second input signal connected to the output gating signal of the third logic module, the third input signal the complement of said initialisation signal;
a monostable comprising a first input signal said logic AND gate output signal, a second input signal, said initialisation signal and a third input signal that maintains the delay and output pulse width characteristics of said monostable constant, said monostable producing as output the encryption clock generator output signal of fixed duration, said monostable output signal produced in response to a pulse on the first input signal when the second input signal is inactive, said monostable reset when the second input signal is active.

13. A device for encrypting/decrypting data according to claim 2 wherein said encryption sampler comprises:
a first data input, the data to be encrypted;
a first clock input, the input clock of regular period;
a second input clock, the encryption clock generator output clock of irregular period;
a first D-type flip-flop, the D input connected to first data input, the clock input connected to the first clock input producing an output signal equivalent to the first data input delayed one-half of a clock period;
a multiplexer with a first input, the first data input, a second input, the delayed first data input, a selection input and producing as an output signal the first multiplexer input or the second multiplexer input in response to the state of the select input;
a decision circuit detecting if the next encryption clock transition is likely to occur at a point in time where the first input data may not be stable producing as output a selection signal for the aforementioned multiplexer, the multiplexer selecting the second input, the delayed first input signal, when the non-stable data sampling condition is detected;
a second D-type flip-flop, sampling the output of the multiplexer with the encryption clock generator output clock of irregular period producing the encrypted data.

14. A device for encrypting/decrypting data according to claim 12 wherein said decision circuit comprises a window comparator formed from a first comparator, a second comparator and a logic AND gate, a first input to the first comparator the time delay value data word, the second input to the first comparator a first metastable threshold value, the output of the first comparator generating a logic-1 state when the first input exceeds the second input, the second comparator with first input the time delay value data word, second input a second metastable threshold value, the output of the second comparator generating a logic-1 state when the first input is less than the second input, the output of each comparator an input to the logic AND gate, the logic AND gate producing a logic one state when the time delay value data bus is between the first metastable threshold value and the second metastable threshold value.

15. A device for encrypting/decrypting data according to claim 3 wherein said decryption sampler comprises a D-type flip-flop with a first input, the encrypted data in serial form synchronous to the encryption clock of irregular period, said D-type flip-flop clocked by the input clock of regular period and producing the decrypted data in serial form synchronous to the input clock of regular period, without producing metastable data.

16. A method for encrypting and decrypting data based on random time sampling, the properties of the random time determined from a personal identification number or biometric data or device specific structure or unclonable structure, or combination thereof, wherein the application of the data encryption process produces encrypted data that when subsequently applied to the decryption process the original data is returned with no loss of information.

17. A method for encrypting and decrypting data according to claim 16 with said encryption process encrypting a first digital data sequence, the first digital data sequence produced by a first clock with a regular period sequence, transforming said first digital data sequence into an encrypted second digital data sequence the first digital data sequence sampled in the encryption process by a second irregularly timed clock sequence of period shorter than the period of the first clock of regular period.

18. A method for encrypting and decrypting data according to claim 16 with said decryption process decrypting a second digital data sequence previously encrypted by a clock with irregular period sequence, transforming second digital data sequence back into an un-encrypted digital data sequence the digital data sequence clocked by a regularly timed clock sequence.

19. A method of producing an irregular sampling clock in a device according to claim 1, for the purpose of encryption and decryption of data, using an encryption clock generator used in both the encryption and decryption processes for producing a clock with an irregular period.

20. A method of claim 19, with sampling clock of irregular period relative to the clock that produced the data in a manner that guarantees the encrypted data contains no metastable data.
